(19) United States
(12) Patent Application Publication
(10) Pub. No.: US 2006/0163858 A1
(43) Pub. Date: Jul. 27, 2006

(54) Support Leg Assistant

(75) Inventor: Barciliso Jerry Giralde, Fresno, CA (US)

Correspondence Address: Mr.Barciliso Jerry Giralde, 3212 W. Floradora Ave., Fresno, CA, 93722, US

(73) Assignee: Mr. Barciliso Jerry Giralde, Fresno, CA (US)

(21) Appl. No.: 10/905,899

(22) Filed: Jan. 25, 2005

(51) Int. Cl. B60S 9/02

(52) U.S. Cl. 280/763.1

(57) ABSTRACT

The Support Leg Assistant is to be use with a recreational vehicle or other vehicles having a pair of support jacks which are raised and lowered by some means of power. The support jacks have a inter leg that is expandable by means of a pin through holes in the support jack and inter leg. To make this adjustment the operator has to get down and under the vehicle and handle some very dirty parts. The Support Leg Assistant is designed to take that task out to the side of the vehicle, where there is ease of accessibility for the operator. The operator can remove the pin then raise or lower the support leg and replace the pin all from the side of the vehicle. It will be safer and cleaner for the operator.

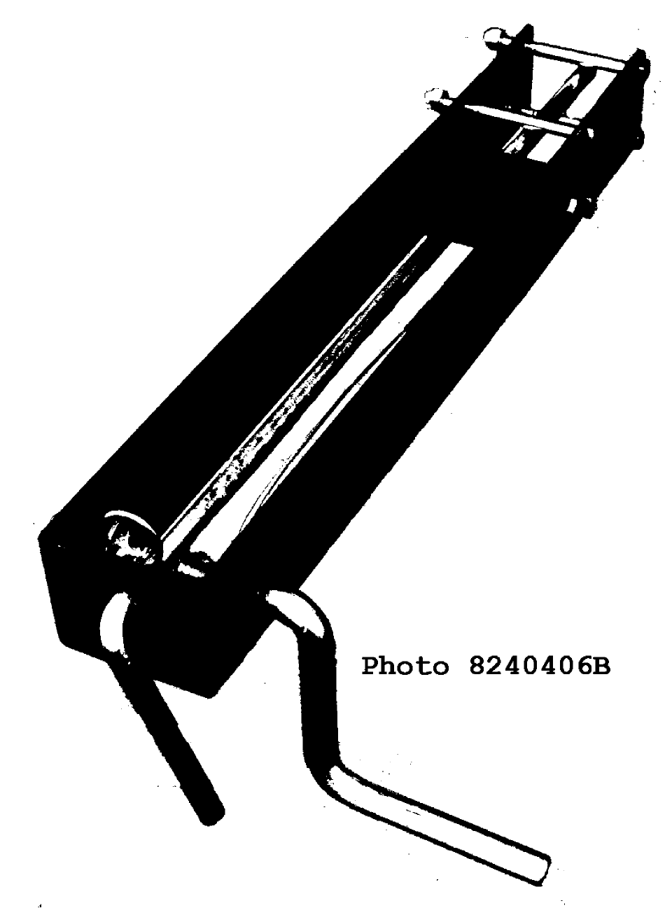

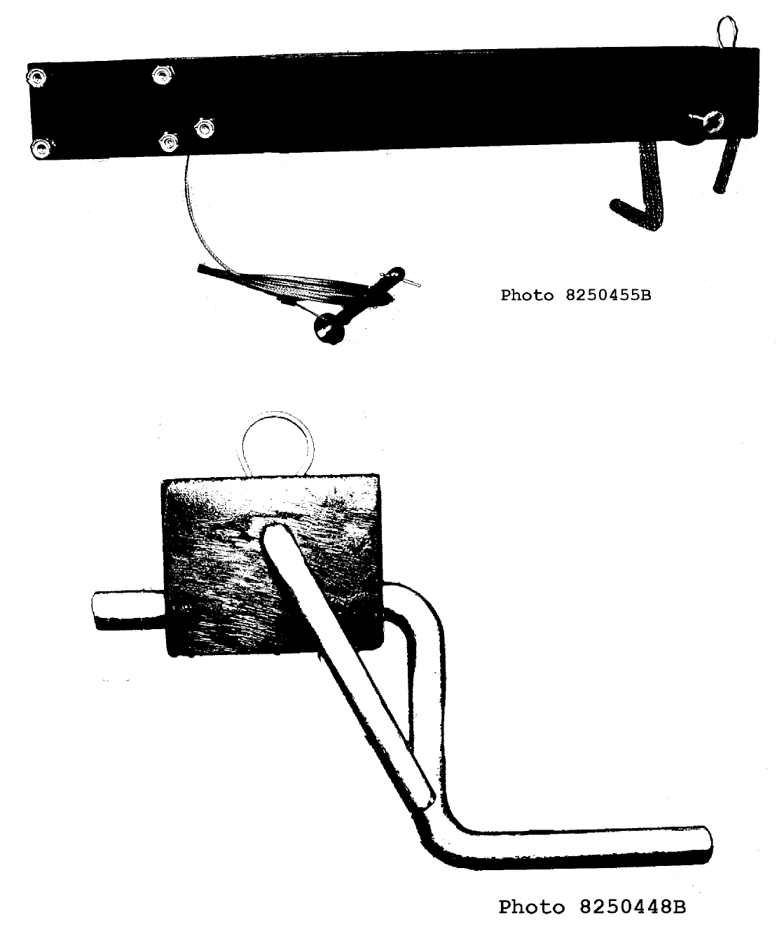

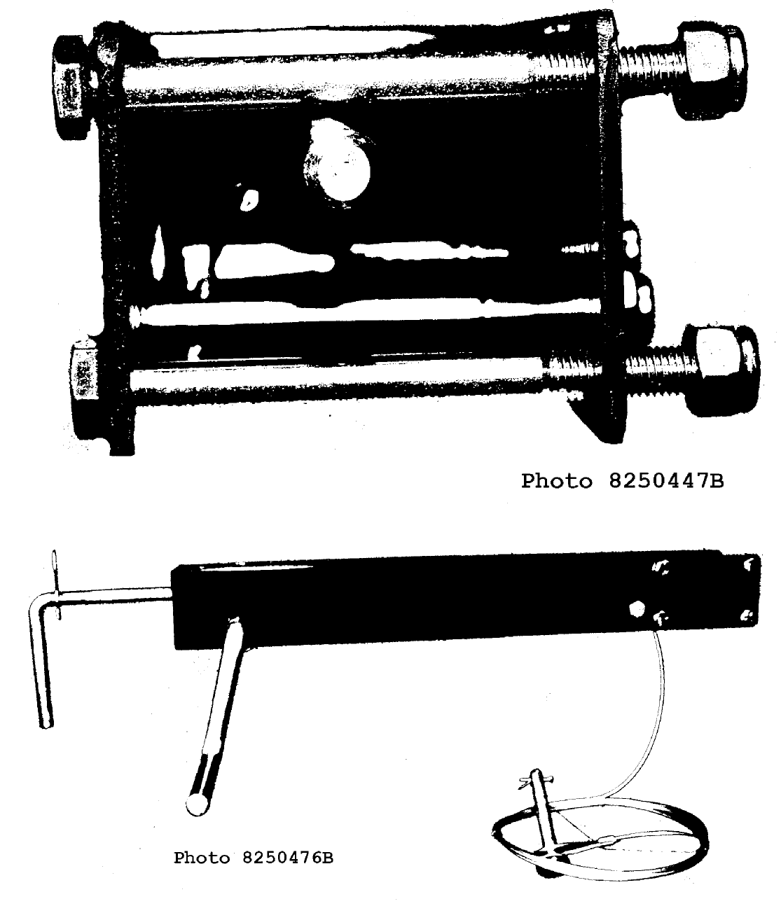

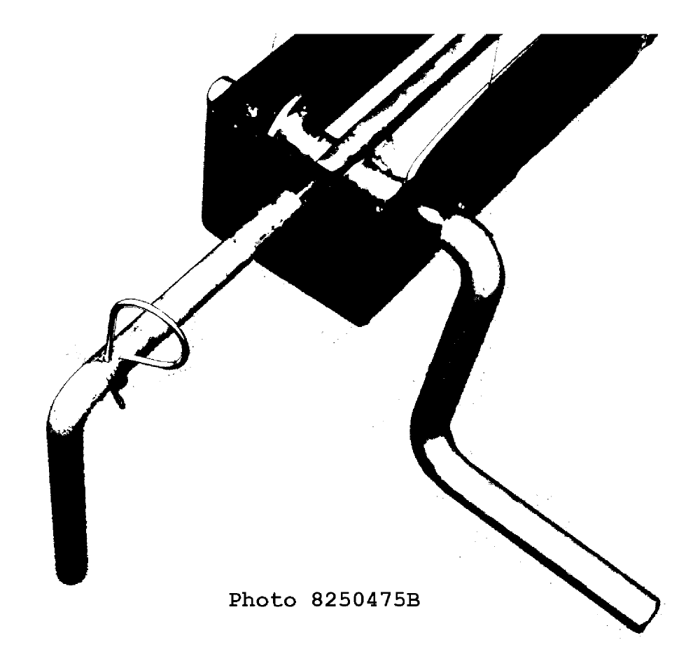

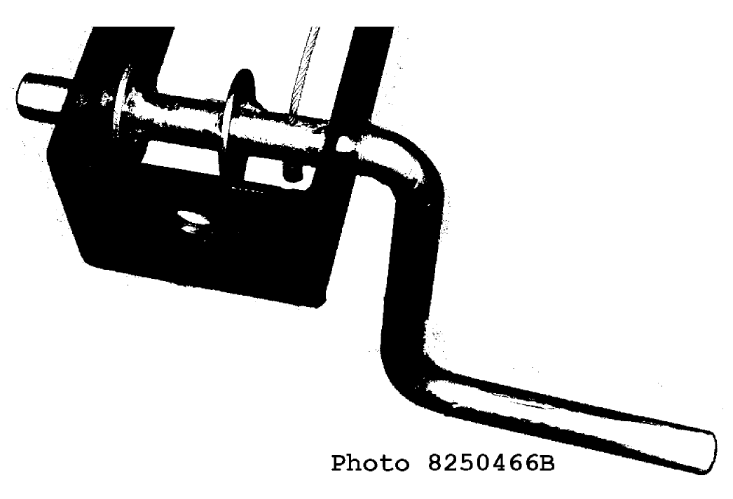

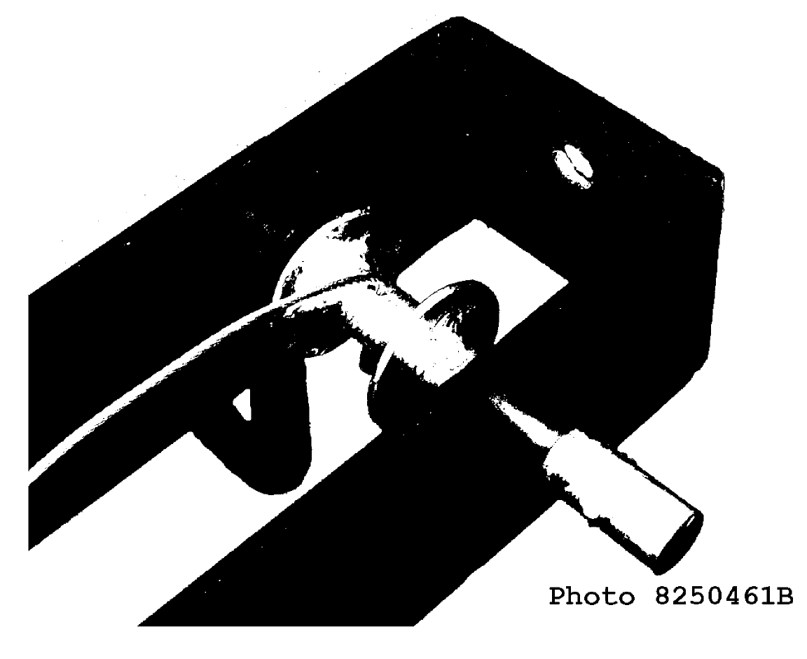

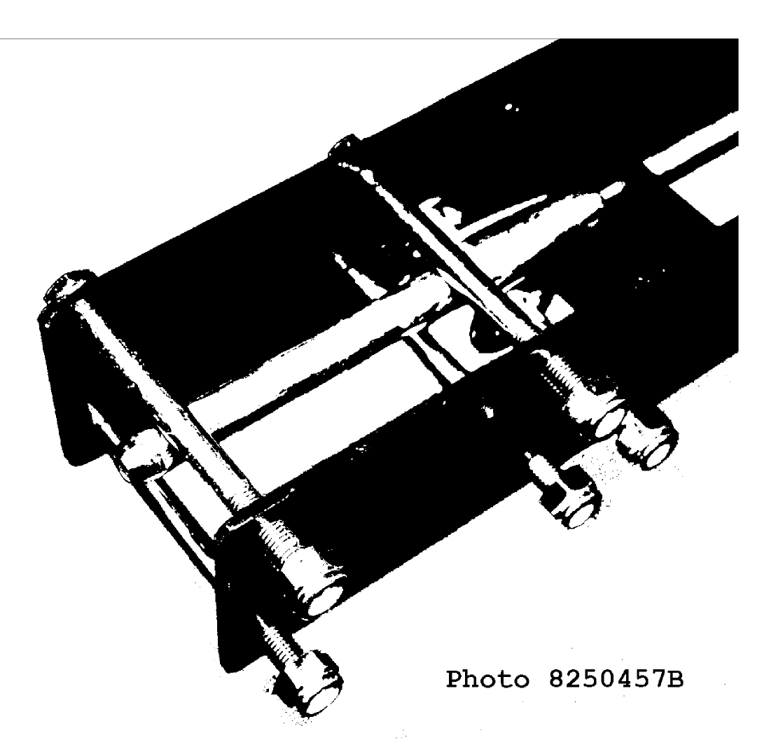

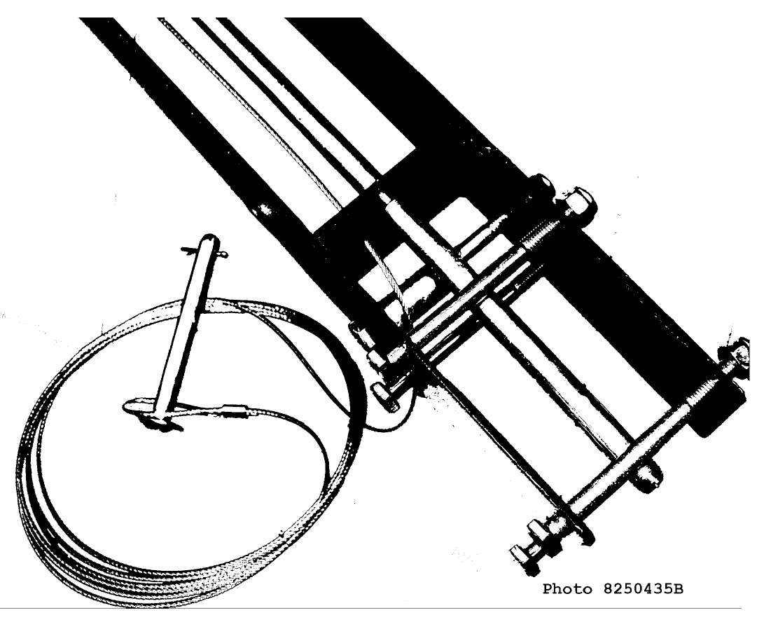

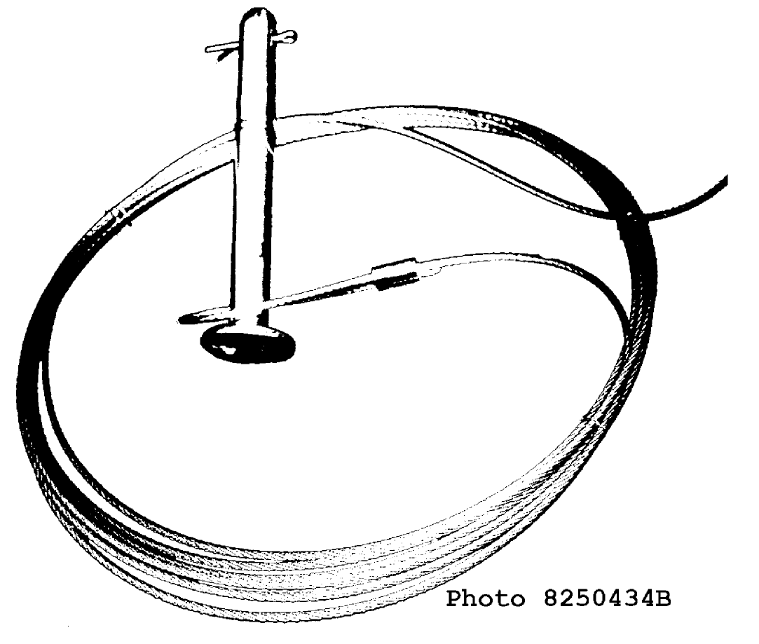

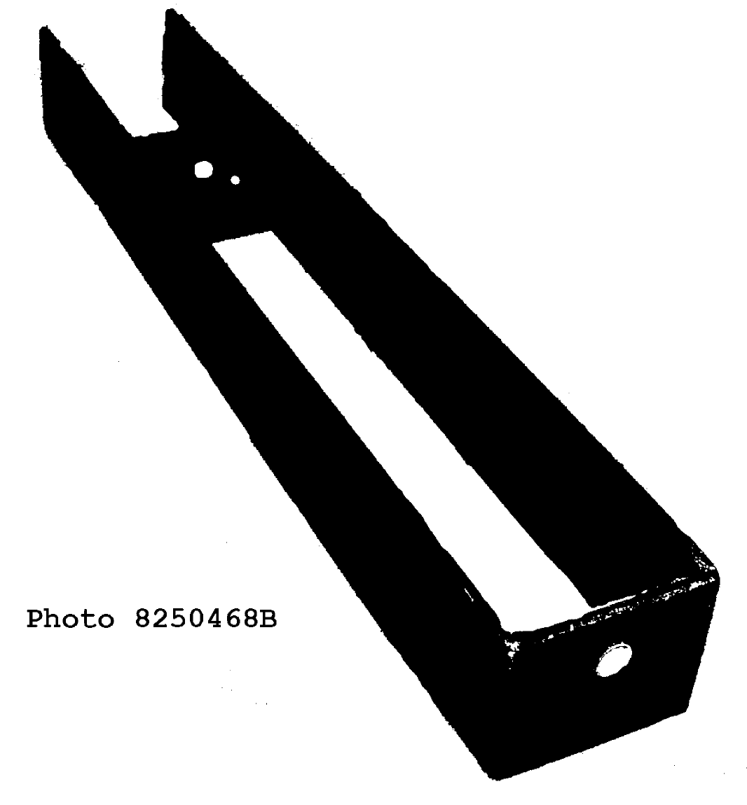

A 2″×16″ frame containing a long pin, a cable and a turn handle.

A mechanism designed to take the task of adjusting the expandable support leg out to the side of the vehicle, where there is ease of accessibility for the operator. The operator can remove the pin then raise or lower the support leg and replace the pin all from the side of the vehicle where it will be safer and cleaner for the operator.

This invention “Support Leg Assistant”, consist of five major parts, a housing that attaches to the support jack, a longer pin and a crank handle, pulley and cable. The Parts needed, will be as follows.

Definition List 1

| Term | Definition |
|---|---|
| 1 | 2″ × 16″ × ⅛″ steel metal bar, varies |
| | with application |
| 1 | 2″ × 2⅛″ × ⅛″ steel metal square, |
| | varies with application |
| 1 | 2″ × 2¼″ × ⅛″ steel metal square, |
| | varies with application |
| 1 | ⅜″ × 20″ steel round stock, varies with |
| | application |
| 1 | ½″ × 20″ steel round stock, varies with |
| | application |
| 5 | ¼″ × 5″ Bolts, varies with application |
| 3 | ½″ washers |
| 3 | ⅜″ washers |
| 1 | 5 ft of 1/16″ wire cable |
| 2 | ferrules |
| 2 | stops |
| 1 | 5/16″ cotter key |
| 1 | ⅜″ locking spring pin |

Drill six holes in each of the 16″ bars, drill one hole in the 2″×2⅛″ metal square, two holes in the 2″×2¼″ metal square, and then weld into the housing form. Using the ⅜″ round stock bend a 90 degree handle at one end on the same end drill a 5/16 hole for the safety pin. Using the ½″ steel round stock make two bends measure 3″ make the first bend then measure 4″ making the second bend in the opposite direction as to form a crank handle. Insert the crank handle in the 2 holes of the frame putting the three washers in the middle of the frame. Weld the washers to the round stock, two to the far sides and one in the middle then drill a 5/16″ hole in the round stock. Insert the ¼″ bolt into the frames with two ⅜″ washers and a one inch ¼″ drilled out of ½″ round stock then weld in line with hole drilled in crank handle. Using the ⅜″ round stock cut a 4″ piece drill a 5/16″ through each end and weld a ⅜″ washer at one of the ends. Route the cable through the washer end of the short pin and the housing to the crank handle put a ferrule at the pin end and the stop at the handle end. The “Support Leg Assistant” is ready to be installed on the jack leg.

Photograph Description

Photo 8240406B is an overall view showing the frame, Pin crank handle and the four mounting bolts.

Photo 8250455B is the front view.

Photo 8250448B is the left side view.

Photo 8250447B is the right side view.

Photo 8250476B is the rear view.

Photo 8250475B is a view of the long pin with a 90 degree bend for a handle and the spring locking key to lock the pin in lock position.

Photo 8250466B is a view of the crank handle, the 5/16″ drilled hole and you can see two of the three washers welded in place.

Photo 8250461 B in this view you can see how the three washers welded in place keep the crank handle centered and makes a pulley for the cable.

Photo 8250457B in this view you can see how the two washers and the drilled out ½″ round stock make a pulley for the cable.

Photo 8250435B in this view you can see the cable run over the pulley and down just before the four mounting bolts.

Photo 8250434B this is a view of the small pin and cable. The pin has a 5/16″ hole drilled at each end with a washer welded on one end. The cable is attached using a ferrule and a stop.

Photo 8250468B this is the view of the frame. The holes can be drilled or punched, the shape can be bent from a single metal bar or cut and welded, and its dimensions will vary depending on the application.

What is claimed is:

1. The Support Leg Assistant, designed to take the task of adjusting the expandable support leg out to the side of the vehicle, where there is ease of accessibility for the operator. The operator can remove the pin then raise or lower the support leg and replace the pin all from the side of the vehicle. It will be safer and cleaner for the operator.
